(19) United States
(12) Patent Application Publication
(10) Pub. No.: US 2021/0070571 A1
(43) Pub. Date: Mar. 11, 2021

(54) PAPER FEED DEVICE AND IMAGE FORMING APPARATUS

(71) Applicant: TOSHIBA TEC KABUSHIKI KAISHA, Tokyo (JP)

(72) Inventors: Katsuya Oshida, Mishima Shizuoka (JP); Brad Wesley Towe, Venetian Way Versailles, KY (US); Michael William Lawrence, Lexington, KY (US); William Michael Conners, Lexington, KY (US)

(21) Appl. No.: 16/564,109

(22) Filed: Sep. 9, 2019

(51) Int. Cl. B65H 5/36; B65H 5/06; B65H 29/52

(52) U.S. Cl. CPC B65H 5/36; B65H 2301/42254; B65H 29/52; B65H 5/06

(57) ABSTRACT

According to one embodiment, a paper feed device includes a cassette, a main body, an actuator, a first elastic member, and a guide member. The actuator reciprocates between first and second directions in the second direction intersecting the first direction. The first elastic member urges the actuator. The guide member includes a base end portion, a front end portion, and a guide unit. The guide unit includes an apex portion overhanging in an opposite direction to the second direction. The base end portion is located at a third position in the second direction. The front end portion is movable between the third and a fourth position separated more than at the first position in the second direction. The guide unit is provided so that the apex portion can be disposed at the same position as an end of the actuator in the second direction at the second position.

### FIELD

Embodiments described herein relate generally to a paper feed device and an image forming apparatus.

### BACKGROUND

An image forming apparatus forms an image transported in a transport direction on a sheet inside. The sheet is discharged from a cassette paper discharge device included in the image forming apparatus.

The cassette paper discharge device includes a cassette capable of being loaded with sheets and a main body which supports the cassette. The cassette is accommodated to be detachably mounted in the main body. A user performs an operation of inserting the cassette toward the main body or drawing the cassette from the main body.

The cassette is positioned in the main body when the cassette is accommodated in the main body. As a result, a sheet on the cassette inserted into the main body is positioned in a transport direction in the cassette paper feed device and a direction orthogonal to the transport direction.

A drawing mechanism is provided in the cassette paper feed device so that the cassette is reliably positioned when a user inserts the cassette into the main body of the paper feed device. The drawing mechanism draws the cassette into the main body when insertion of the cassette is closely completed. Insertion failure of the cassette is prevented by the drawing mechanism.

However, when the cassette is drawn, resistance from the drawing mechanism is received. Therefore, there is a possibility of a load on a user increasing.

### BRIEF DESCRIPTION OF THE DRAWINGS

FIG. 1 is a schematic sectional view illustrating an overall configuration example of an image forming apparatus according to an embodiment;

FIG. 2 is a schematic perspective view illustrating an example of a paper feed device;

FIG. 3 is a schematic perspective view illustrating an internal configuration of the paper feed device;

FIG. 4 is a schematic exploded view illustrating a lock release mechanism of the paper feed device;

FIG. 5 is a schematic side view illustrating a drawing mechanism of the paper feed device;

FIG. 6 is a schematic side view illustrating main units when a cassette of the paper feed device is drawn;

FIG. 7 is a schematic side view illustrating an operation of inserting the paper feed device;

FIG. 8 is a schematic side view illustrating an operation of inserting the paper feed device;

FIG. 9 is a schematic side view illustrating an operation of inserting the paper feed device;

FIG. 10 is a schematic side view illustrating an operation of drawing the paper feed device;

FIG. 11 is a schematic view illustrating a relative motion of an actuator and a guide member of the paper feed device; and

FIG. 12 is a schematic view illustrating an example of a guide member of a paper feed device according to a modification example of the embodiment.

### DETAILED DESCRIPTION

In general, according to one embodiment, a paper feed device includes a cassette, a main body, an actuator, a first elastic member, and a guide member. The cassette can load sheets. The main body supports the cassette so that the cassette can reciprocate in a first direction and an opposite direction to the first direction. The actuator is supported by the main body. Further, the actuator can reciprocate between a first position and a second position located to be separate more than the first position in an opposite direction to the second direction in the second direction intersecting the first direction. The first elastic member urges the actuator in the second direction. The guide member is provided in the cassette. Further, the guide member can cross along a reciprocation path of the actuator in the second direction when the cassette reciprocates. Further, the guide member includes a front end portion located upstream in the first direction, a base end portion located downstream, and a guide unit formed between the base end portion and the front end portion. The guide unit includes an apex portion overhanging in the opposite direction to the second direction. The base end portion is located in the second direction at the same position as an end portion of the actuator located at the first position on an opposite side to the second direction or a third position located to be separate more than the end portion in the opposite direction to the second direction. The front end portion is provided in the second direction to be movable between the third position and a fourth position located to be separate more than the first position in the second direction. The guide unit is provided so that the apex portion can be disposed at the same position as the end portion of the actuator in the second direction at the second position in the second direction.

Hereinafter, a paper feed device and an image forming apparatus according to an embodiment will be described with reference to the drawings.

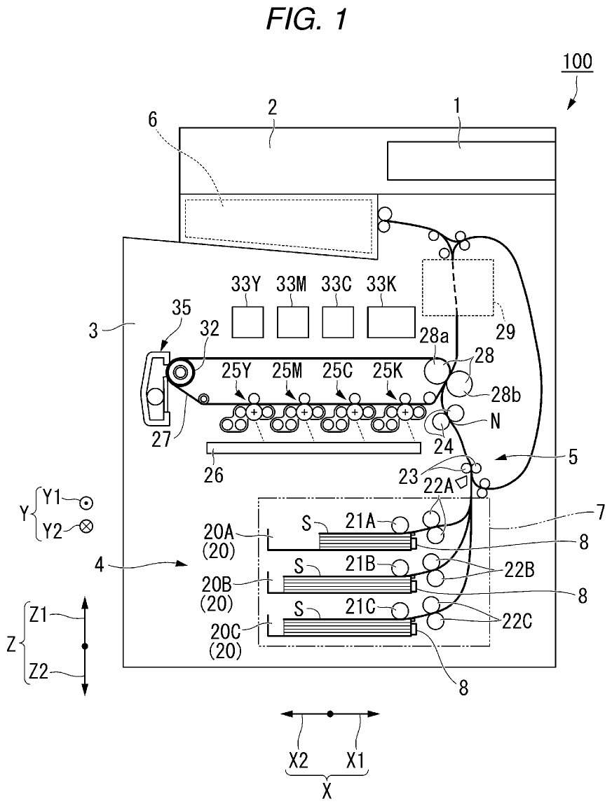

FIG. 1 is a schematic sectional view illustrating an overall configuration example of an image forming apparatus according to an embodiment. In the following drawings, the same reference numerals are given to the same or equivalent configurations unless otherwise mentioned.

As illustrated in FIG. 1, an image forming apparatus 100 according to the embodiment includes a control panel 1, a scanner unit 2, a printer unit 3, a sheet supply unit 4 (a paper feed device), a sheet supply unit 5, a transport unit 5, and a body control unit 6.

Hereinafter, when relative positions in the image forming apparatus 100 are referred to, an X1 direction, an X2 direction, a Y1 direction, a Y2 direction, a Z1 direction, and a Z2 direction illustrated in the drawings are used in some cases.

The X1 direction is a direction oriented from the left to the right when a user stands in front of the image forming apparatus 100 (front side of a page surface of FIG. 1). The X2 direction is an opposite direction to the X1 direction.

The Y1 direction is a direction oriented from the rear surface to the front surface of the image forming apparatus 100. The Y2 direction is an opposite direction to the Y1 direction.

The Z1 direction is an upward vertical direction. The Z2 direction is a downward vertical direction.

When the X1 (Y1 or Z1) direction and the X2 (Y2 or Z2) direction do not matter or both directions are included, the X1 and X2 directions are simply referred to as the X (Y or Z) direction.

The control panel 1 operates the image forming apparatus 100 when the user performs operation.

The scanner unit 2 reads image information of a copy target object as brightness and darkness of light. The scanner unit 2 outputs the read image information to the printer unit 3.

The printer unit 3 forms an image on a sheet S based on image information from the scanner unit 2 or an external unit.

The printer unit 3 forms an output image (toner image) with developer including toner. The printer unit 3 transfers the toner image to the surface of the sheet S. The printer unit 3 pressurizes heat and pressure to the toner image on the surface of the sheet S and fixes the toner image to the sheet S.

The sheet supply unit 4 supplies the sheet S to the printer unit 3 one by one at a timing at which the printer unit 3 forms the toner image.

The sheet supply unit 4 includes a plurality of paper feed cassettes 20A, 20B, and 20C (cassettes). The paper feed cassettes 20A, 20B, and 20C can accommodate the kinds of stacked sheets S with sizes set in advance.

The paper feed cassettes 20A, 20B, and 20C can be detachably mounted in the main body 7 of the sheet supply unit 4 in the Y direction. The paper feed cassettes 20A, 20B, and 20C are disposed to be stacked in this order from the upper side to the down side when being mounted in the sheet supply unit 4.

The paper feed cassettes 20A, 20B, and 20C have a common configuration. Hereinafter, when it is not necessary to specify positions in the up and down directions, the paper feed cassettes 20A, 20B, and 20C are simply referred to as the paper feed cassettes 20 in some cases.

Each paper feed cassette 20 and the main body 7 are connected to be detachably mounted via at least the drawing mechanism 8. A configuration of the drawing mechanism 8 corresponding to each paper feed cassette 20 is common. The configuration of the drawing mechanism 8 will be described below.

The sheet supply unit 4 includes pickup rollers 21A, 21B, and 21C to correspond to the paper feed cassettes 20A, 20B, and 20C, respectively. The pickup rollers 21A, 21B, and 21C take the sheets S loaded in the paper feed cassettes 20A, 20B, and 20C one by one, respectively. The pickup rollers 21A, 21B, and 21C transport the taken sheets S to the transport unit 5 toward the printer unit 3. In each of the paper feed cassettes 20A, 20B, and 20C, the sheet S is transported in the X1 direction (a transport direction).

The transport unit 5 includes transport rollers 23 and resist rollers 24. The transport unit 5 transports the sheets S supplied from the pickup rollers 21A, 21B, and 21C to the resist rollers 24. The resist rollers 24 transport the sheets S at timing at which the printer unit 3 transfers toner images to the sheets S.

The transport rollers 23 hit the tip end of the sheet S in the transport direction on a nip N of the resist rollers 24. The transport rollers 23 straighten the position of the tip end of the sheet S in the transport direction by bending the sheet S.

The resist rollers 24 align the tip end of the sheet S sent from the transport rollers 23 in the nip N. Further, the resist rollers 24 transport the sheet S to the side of a transfer unit 28 to be described below.

The printer unit 3 includes image forming units 25Y, 25M, 25C, and 25K, an exposure unit 26, an intermediate transfer belt 27, a transfer unit 28, a fixer 29, and a transfer belt cleaning unit 35.

The image forming units 25Y, 25M, 25C, and 25K are disposed in this order in the X1 direction. Each of the image forming units 25Y, 25M, 25C, and 25K forms a toner image to be transferred to the sheet S to the intermediate transfer belt 27.

Each of the image forming units 25Y, 25M, 25C, and 25K includes a photoconductive drum. The image forming units 25Y, 25M, 25C, and 25K form toner images of yellow, magenta, cyan, and black on the photoconductive drums, respectively.

A charger, a developing unit, a primary transfer roller, a cleaning unit, and a static eliminator are disposed around each photoconductive drum. The primary transfer roller faces the photoconductive drum. The intermediate transfer belt 27 is pinched between the primary transfer roller and the photoconductive drum. The exposure unit 26 is disposed below the charger and the developing unit.

Toner cartridges 33Y, 33M, 33C, and 33K are disposed above the image forming units 25Y, 25M, 25C, and 25K. The toner cartridges 33Y, 33M, 33C, and 33K contain yellow toner, magenta toner, cyan toner, and black toner. Each toner is supplied to each of the image forming units 25Y, 25M, 25C, and 25K via a toner supply tube (not illustrated).

The exposure unit 26 radiates laser light to the surface of each of the charged photoconductive drum. Emission of the laser light is controlled based on image information. The exposure unit 26 can be configured to radiate LED light instead of laser light.

The exposure unit 26 is supplied with image information corresponding to yellow, magenta, cyan, and black. The exposure unit 26 forms an electrostatic latent image based on the image information on the surface of each photoconductive drum.

The intermediate transfer belt 27 is an endless belt. The internal circumferential surface of the intermediate transfer belt 27 comes into contact with a support roller 28a at a position in the X1 direction farthest in a stretch direction. The internal circumferential surface of the intermediate transfer belt 27 comes into contact with a transfer belt roller 32 at a position in the X2 direction farthest in the stretch direction.

The support roller 28a is a part of the transfer unit 28 to be described below. The support roller 28a guides the intermediate transfer belt 27 to a secondary transfer position.

The transfer belt roller 32 guides the intermediate transfer belt 27 to a cleaning position.

On the illustrated lower surface side of the intermediate transfer belt 27, the image forming units 25Y, 25M, 25C, and 25K are disposed in this order in the X1 direction except for the primary transfer rollers.

Each primary transfer roller of the image forming units 25Y, 25M, 25C, and 25K transfers (primarily transfers) a toner image on the surface of each photoconductive drum to the intermediate transfer belt 27.

In the intermediate transfer belt 27, a transfer unit 28 is disposed at a position adjacent to the image forming unit 25K.

The transfer unit 28 includes the support roller 28a and a secondary transfer roller 28b. A position at which the secondary transfer roller 28b comes into contact with the intermediate transfer belt 27 is a secondary transfer position.

The transfer unit 28 transfers a toner image charged on the intermediate transfer belt 27 to the surface of the sheet S at the secondary transfer position.

The fixer 29 gives heat and pressure to the sheet S. The fixer 29 fixes the toner image transferred to the sheet S in accordance with the heat and the pressure.

The transfer belt cleaning unit 35 scrapes the toner on the surface of the intermediate transfer belt 27.

The body control unit 6 controls each device portion of the image forming apparatus 100.

Next, the detailed configuration of the sheet supply unit 4 will be described focusing on the drawing mechanism 8.

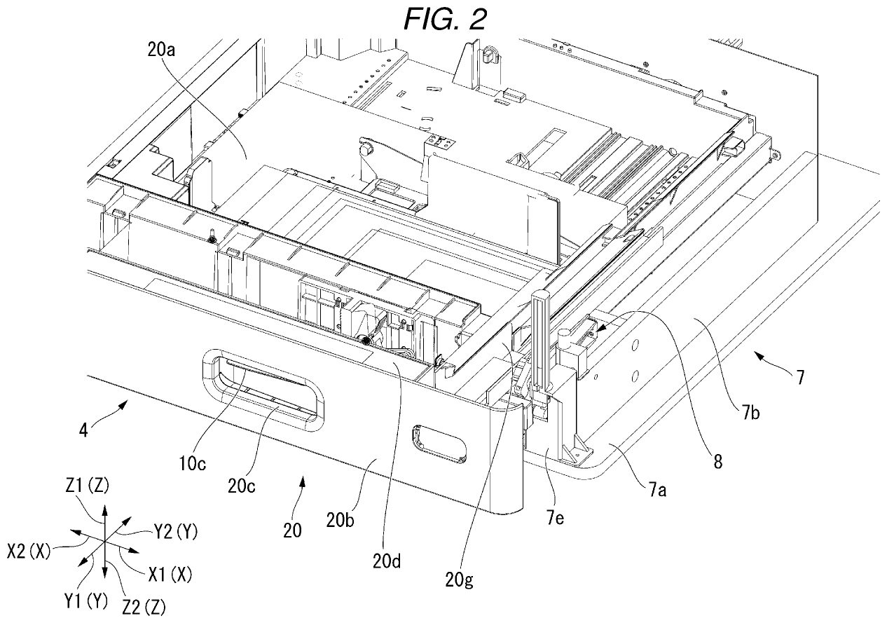

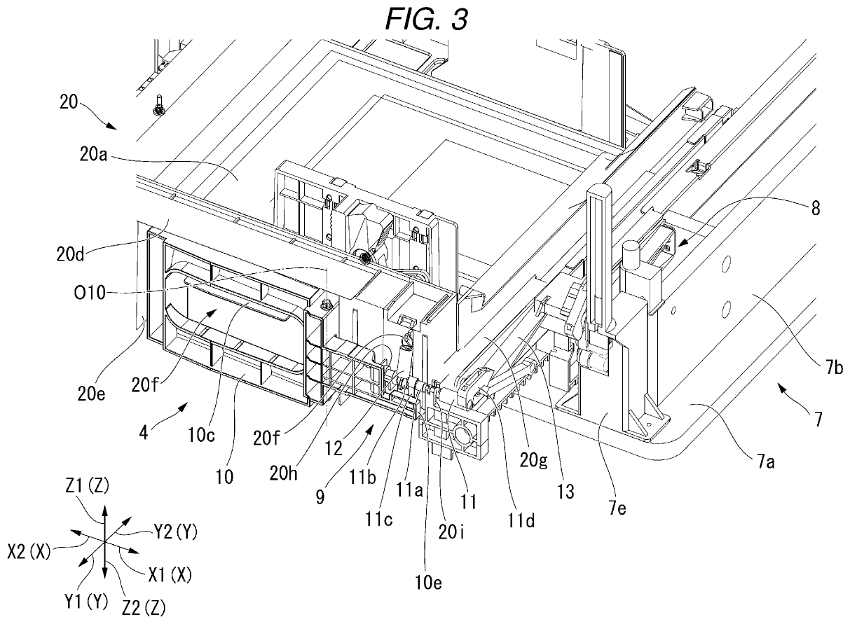

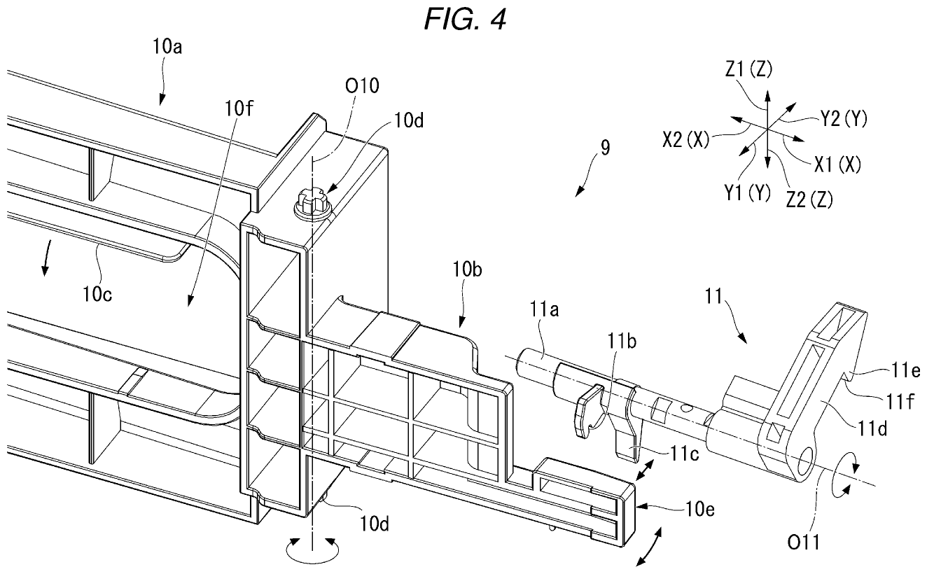

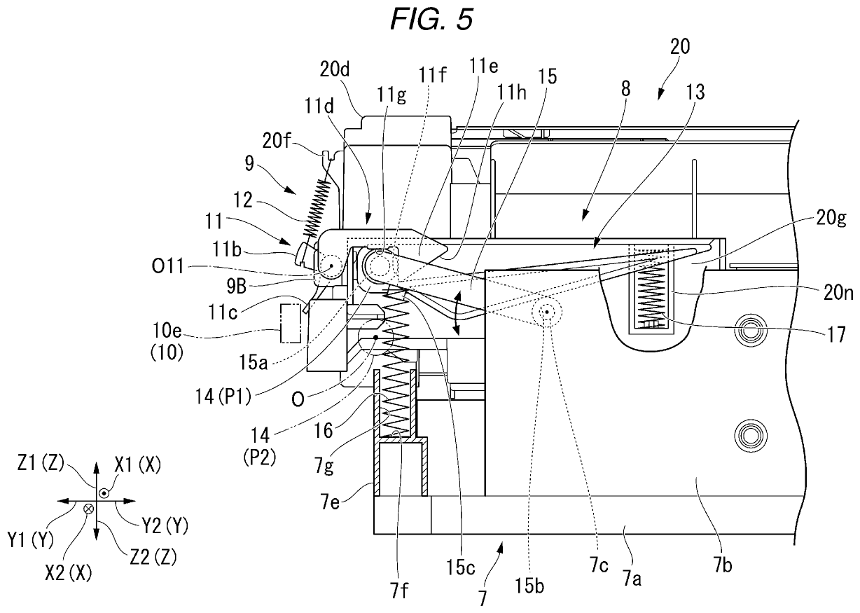

FIG. 2 is a schematic perspective view illustrating an example of the paper feed device according to the embodiment. FIG. 3 is a schematic perspective view illustrating an internal configuration of the paper feed device according to the embodiment. FIG. 4 is a schematic exploded view illustrating a lock release mechanism of the paper feed device according to the embodiment. FIG. 5 is a schematic side view illustrating the drawing mechanism of the paper feed device according to the embodiment.

As illustrated in FIG. 2, the paper feed cassette 20 includes a cassette body 20a and a front cover 20b.

The cassette body 20a is formed in a box shape in which the sheets S can be loaded. A front side plate 20d is provided at an end of the cassette body 20a in the Y1 direction. Aright side plate 20g extending from the front side plate 20d in the Y2 direction is formed at an end of the cassette body 20a in the X1 direction.

The cassette body 20a is supported so that the cassette body 20a can reciprocate in the Y2 direction (a first direction) and the Y1 direction (an opposite direction to the first direction) by a slide unit (not illustrated) provided between the cassette body 20a and the main body 7.

Hereinafter, movement of a forward path of the paper feed cassette 20 in the Y2 direction is referred to as advance and movement of a backward path in the Y1 direction is referred to as retreat.

The front cover 20b covers the front side plate 20d in the Y direction. An opening 20c penetrates in the middle of the front cover 20b. The opening 20c has a size in which fingers of the user can be inserted.

As the internal mechanism of the cassette body 20a is illustrated in FIG. 3, a depression portion 20e depressed in the Y2 direction is formed in the middle of the front sideplate 20d in the X direction. The depression portion 20e is formed in a rectangular shape long in the X direction when viewed in the Y2 direction.

The depression portion 20e accommodates a part of a release lever 10 to be described below between the depression portion 20e and the front cover 20b (not illustrated).

A lock release mechanism 9 is provided between the cassette body 20a and the front cover 20b. The lock release mechanism 9 is a mechanism that switches between a lock state in which the paper feed cassette 20 may not be retreated and a lock release state in which the paper feed cassette 20 can be retreated when the paper feed cassette 20 is inserted into the main body 7.

The lock release mechanism 9 includes a release lever 10, a lock member 11 (stopper), and a spring 12.

The release lever 10 includes a handle 10a and an operational lever 10b in the X1 direction in this order.

The handle 10a includes an external form of a rectangular shape which can be accommodated in the depression portion 20e. In the middle of the handle 10a, an opening 10f that is long in the X direction is opened in the Y1 direction. In the internal edge of the opening 10f in the Z1 direction, a grip portion 10c (a stopper release operation portion) which can be gripped downward with a hand of the user is formed.

As illustrated in FIG. 4, the operational lever 10b is connected to an end of the handle 10a in the X1 direction. The operational lever 10b is considered as a plate shape and extends in the X1 direction. A pressurization portion 10e that pressurizes the lock member 11 to be described below in the Y2 direction is formed at the front end portion of the operational lever 10b. The pressurization portion 10e is formed in a rod-like shape or a plate shape extending in the X1 direction.

The release lever 10 has a plate shape extending in the X1 direction as a whole. In the release lever 10, rotational shafts 10d protrude in the Z1 direction and the Z2 direction in connection portions of the handle 10a and the operational lever 10b.

Each rotational shaft 10d is disposed at the same axle as a central shaft line O10 extending in the Z direction.

Each rotational shaft 10d is supported to be rotatable around the central shaft line O10 by a bearing (not illustrated) provided in the front side plate 20d.

The lock member 11 includes a rotational shaft 11a, a hook 11b, a first arm 11c, and a second arm 11d.

The rotational shaft 11a extends in the X direction. The hook 11b, the first arm 11c, and the second arm 11d are provided in this order in the rotational shaft 11a in the X1 direction.

As illustrated in FIG. 3, an end of the rotational shaft 11a in the X1 direction is supported to be rotatable around a central shaft line O11 of the rotational shaft 11a by a bearing 20h. The bearing 20h is provided in the front side plate 20d.

Further, the rotational shaft 11a is supported to be rotatable around the central shaft line O11 by a bearing 20i between the first arm 11c and the second arm 11d. The bearing 20i is provided in the front side plate 20d.

As illustrated in FIG. 4, the hook 11b protrudes in the outward radial direction of the rotational shaft 11a. The hook 11b is formed in a hooked shape that can lock the spring 12 to be described below.

The first arm 11c has a plate shape and a rod-like shape protruding in the outward radial direction of the rotational shaft 11a.

As illustrated in FIG. 3, in a state in which the lock member 11 is supported by the bearings 20h and 20i, the first arm 11c comes into contact with the pressurization portion 10e adjacent in the Y1 direction. The first arm 11c receives a pressurization force from the pressurization portion 10e in accordance with rotation around the central shaft line O10 of the lock member 11. The lock member 11 is rotated around the central shaft line O11 in accordance with a moment of the pressurization force received by the first arm 11c.

As illustrated in FIG. 4, the second arm 11d protrudes in the outward radial direction from the front end of the rotational shaft 11a in the X1 direction. An engagement protrusion 11e protrudes laterally at the front end of the second arm 11d in a protrusion direction.

Here, the configuration of the lock member 11 viewed in the X direction will be described based on disposition of FIG. 5. FIG. 5 illustrates a lock state of the lock release mechanism 9.

As illustrated in FIG. 5, the second arm 11d extends in the Y2 direction in a lock state. This disposition is a fifth position at which a roller 14 can be locked in the Y2 direction, as will be described.

At this time, in the Y1 direction, the hook 11b extends in an inclination direction oriented in the Z1 direction. In the Z2 direction, the first arm 11c extends in an inclination direction oriented in the Y1 direction. The front end of the first arm 11c comes into contact with a side surface of the pressurization portion 10e in the Y2 direction.

The engagement protrusion 11e is formed in a triangular shape protruding in the Z2 direction from the side surface of the second arm 11d in the Z2 direction. A first lock surface 11f (a fourth guide surface) which is a side surface of the engagement protrusion 11e in the Y1 direction is formed as a planar surface orthogonal in the Y direction. That is, the first lock surface 11f extends in a direction intersecting the Y2 direction at the fifth position and the front end of the first lock surface 11f in the extension direction (the Z2 direction) is located near a front-end edge 13B. Therefore, the first lock surface 11f serves a fourth guide surface that guides the roller 14 moving in the Z1 direction along a second guide surface 13c to a lock on the first lock surface 11f.

The first lock surface 11f can lock in the roller 14 to be described below in the Y1 direction.

From the lower end of the first lock surface 11f (the end in the Z2 direction) in the Y2 direction, an inclination surface 11h which is a side surface of the engagement protrusion 11e is inclined in an inclination direction oriented in the Z1 direction. The inclination surface 11h may be a planar surface or a curved surface. In the example illustrated in FIG. 5, the inclination surface 11h is a planar surface.

A second lock surface 11g is formed on a side surface of the second arm 11d in the Z2 direction. The second lock surface 11g is formed as a planar surface orthogonal to the Z direction. The second lock surface 11g can lock in the roller 14 to be described below in the Z2 direction.

The spring 12 is an example of an elastic member that generates a clockwise rotational urging force about the central shaft line O11 for the lock member 11 when viewed in the X2 direction. For example, the spring 12 may be configured as a pulling coil spring.

The spring 12 is stretched between the hook 11b and a hook 20f of the front side plate 20d in a state in which the spring 12 extends from its natural state. Thus, the hook 11b receives a moment of a clockwise rotational force (as illustrated). At this time, when the pressurization portion 10e comes into contact with the first arm 11c, a moment of a force in the lock member 11 is balanced. Therefore, the lock member 11 stops at a position of a lock state.

As illustrated in FIG. 3, the main body 7 includes a base 7a in the lower portion of the paper feed cassette 20. At the end of the base 7a in the X1 direction, a side plate 7b is provided at a position separated from the right side plate 20g in the X1 direction. The side plate 7b extends in the Y direction. A slide unit (not illustrated) that supports the paper feed cassette 20 to be able to advance or retreat (reciprocate) the paper feed cassette 20 in the Y2 direction and the Y1 direction is disposed on the surface of the side plate 7b in the X2 direction. In the main body 7, the slide unit is also provided on a sideplate (not illustrated) adjacent to the side surface of the paper feed cassette 20 in the X2 direction.

The configuration of the slide unit is not particularly limited. For example, a step-shaped unit, a groove unit, a rail-shaped unit, or the like extending in the X direction may be used as the slide unit. A lock portion that locks to be slidable with the slide unit is provided on the side surface of the paper feed cassette 20 in the X1 direction and the X2 direction in accordance with the shape of the slide unit.

The drawing mechanism 8 is provided between the side plate 7b and the right side plate 20g of the paper feed cassette 20.

The drawing mechanism 8 is a mechanism that smoothly inserts the paper feed cassette 20 into the main body 7.

As illustrated in FIG. 5, the drawing mechanism 8 includes the roller 14 (actuator), a rotational arm 15, a first spring 16 (a first elastic member), a guide member 13, and a second spring 17 (a second elastic member).

The roller 14 is formed in a cylindrical shape. The roller 14 is supported to be rotatable by a rotational support shaft 15a fixed to the rotational arm 15 to be described below. The support state by the rotational arm 15, the central shaft line of the roller 14 extends in the X direction.

The roller 14 is formed of, for example, a resin material with good sliding.

The roller 14 locks the first lock surface 11f in the Z1 direction and locks the second lock surface 11g in the Y2 direction in the lock state of the paper feed cassette 20.

The rotational arm 15 supports the roller 14 to be rotatable about the central shaft of the roller 14 and to be movable with respect to the main body 7 in the Z direction. The rotational arm 15 extends in the substantial Y direction in the disposition of the lock state. At an end of the rotational arm 15 in the Y1 direction, the rotational support shaft 15a extending in the X2 direction protrudes from the side surface in the X2 direction. The rotational support shaft 15a supports the roller 14 to be rotatable.

A hole 15b penetrated in the X direction is formed at the end of the rotational arm 15 in the Y2 direction. A rotational support shaft 7c extending in the X2 direction from the surface of the sideplate 7b in the X2 direction is inserted into the hole 15b. The rotational support shaft 7c is provided at a position deviating from the center of the roller 14 in the Z2 direction in the lock state. Thus, in the Y1 direction, the rotational arm 15 in the lock state is inclined in the inclination direction oriented in the Z1 direction. However, since an inclination angle with respect to the horizontal plane is small, the rotational arm 15 extends substantially horizontally.

Thus, the rotational arm 15 is supported to be rotatable using the rotational support shaft 7c as a rotational center.

The first spring 16 is an example of the first elastic member that urges the roller 14 in the Z1 direction via the rotational arm 15. The configuration of the first spring 16 is not particularly limited as long as the roller 14 can be urged in the Z1 direction. In the example illustrated in FIG. 5, the first spring 16 is a coil spring that can be compressed and pulled. The first spring 16 is disposed to extend in the Z direction.

The end of the first spring 16 in the Z1 direction locks in a spring lock portion 15c of the rotational arm 15.

The end of the first spring 16 in the Z2 direction locks in a first spring holder 7e. The first spring holder 7e is fixed to the base 7a.

The first spring holder 7e includes a lock portion 7f that locks the end of the first spring 16 in the Z2 direction and an accommodation hole 7g that guides the lower portion of the first spring 16 to the lateral side.

The first spring 16 may have a natural length or may be compressed more than the natural length at the position of the roller 14 in the lock state. Here, the first spring 16 is more preferably to have the natural length at the position of the roller 14 in the lock state. Hereinafter, a case in which the first spring 16 is considered to have the natural length at the position of the roller 14 at the lock state will be described as an example.

In this configuration, the roller 14 is supported to be rotatable about the rotational support shaft 7c in a state in which the roller 14 is urged in the Z1 direction. Since the rotational arm 15 extends substantially horizontally, a rotational trajectory of the rotation of the rotational support shaft 7c of the roller 14 runs along a substantially vertical line in a movement range of the roller 14 to be described below.

As will be described below, the roller 14 can reciprocate between two different positions in the Z1 direction (a second direction) when the drawing mechanism 8 operates. A position of the roller 14 closest in the Z1 direction (a position indicated by a solid line in FIG. 5 which is represented as the position of the center O of the roller 14 in the Z direction; hereinafter this position is referred to as a first position P1) is defined by causing a lock portion (not illustrated) provided in the main body 7 to regulate clockwise rotation (illustrated) of the rotational arm 15 in the embodiment.

A position of the roller 14 closest in the Z2 direction (a position indicated by a two-dot chain line in FIG. 5 which is represented as the position of the center O of the roller 14 in the Z direction; hereinafter referred to as a second position P2) is defined in accordance with the position of an apex portion 13b of the guide member 13 to be described below locked by the roller 14.

In the embodiment, the center of the rotational support shaft 7c and the hole 15b is disposed at a position at which the first and second positions of the roller 14 are bisected in the Z direction. Therefore, the center of the roller 14 at the first and second positions is located at the same position in the Y direction.

An elastic force applied to the roller 14 from the first spring 16 decreases as a distance of the roller 14 in the Z direction from the lock portion 7f increases. In particular, in the embodiment, the elastic force from the first spring 16 is not applied to the roller 14 at the position of the lock state.

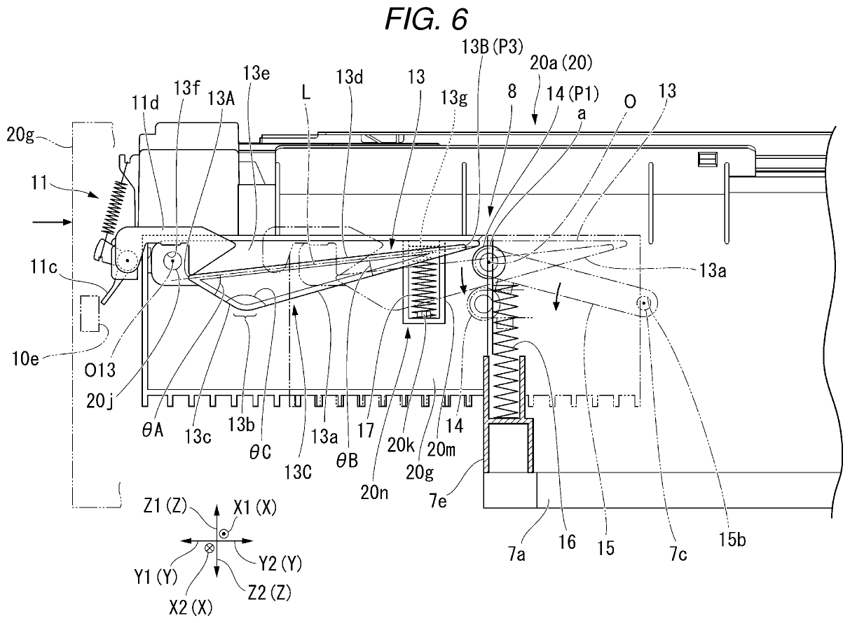

Next, the guide member 13 will be described with reference to FIG. 6.

FIG. 6 is a schematic side view illustrating main units when a cassette of the paper feed device according to the embodiment is drawn.

As illustrated in FIG. 6, the guide member 13 includes a substrate 13e and a projection 13C.

The substrate 13e is formed as a flat plate disposed along the surface of the right side plate 20g in the X1 direction. In the substrate 13e, an engagement hole 13f near to the end in the Y1 direction is formed. The engagement hole 13f engages with a rotational support shaft 20j protruding from the right side plate 20g in the X1 direction to be rotatable. Thus, the guide member 13 is rotatable about a central shaft line O13 of the engagement hole 13f.

Hereinafter, the shape of each portion of the guide member 13 will be described based on disposition in a state in which the paper feed cassette 20 illustrated in FIG. 6 is drawn unless otherwise mentioned.

The projection 13C protrudes in the X1 direction from the surface of the substrate 13e in the X1 direction. Therefore, the outer circumferential surface of the projection 13C extends in a direction perpendicular to the substrate 13e

The outer shape of the projection 13C is a substantially triangular shape in which the bottom side extends in the substantial Y direction and the apex is oriented in the Z2 direction when viewed in the X direction (third direction).

In the outer circumference of the projection 13C, a base-end edge portion 13A (base end portion) is formed at the end in the Y1 direction and a front-end edge portion 13B (front end portion) is formed at the end in the Y2 direction. The base-end edge portion 13A is located downstream in the Y2 direction. The front-end edge portion 13B is located upstream in the Y2 direction. A third guide surface 13d is formed between the base-end edge portion 13A and the front-end edge portion 13B.

The third guide surface 13d may be a planar surface or may be a curved surface. In the example illustrated in FIG. 6, the third guide surface 13d is a planar surface running along a straight line L binding the base-end edge portion 13A to the front-end edge portion 13B.

The projection 13C overhangs in the Z2 direction (an overhang direction) from the straight line L between the base-end edge portion 13A and the front-end edge portion 13B. On the overhang side of the protrusion 13C, a first guide surface 13a, the apex portion 13b, and a second guide surface 13c are formed in this order from the front-end edge portion 13B to the base-end edge portion 13A. The first guide surface 13a, the apex portion 13b, and the second guide surface 13c form a guide unit in the guide member 13.

The first guide surface 13a forms a OB (where OB is an acute angle) with respect to the straight line L and is an inclination surface running toward the apex portion 13b. The first guide surface 13a may be a planar surface or a curved surface. In the example illustrated in FIG. 6, the first guide surface 13a is a planar surface.

The apex portion 13b is a front end portion in the overhang direction and is a curved surface smoothly connecting the first guide surface 13a to the second guide surface 13c to be described below. The shape of the curved surface is not particularly limited as long as the shape of the curved surface is a convexly curved surface that smoothly changes. A cross-sectional shape of the apex portion 13b orthogonal in the X direction may be, for example, an arc shape or an elliptical shape.

The second guide surface 13c forms a θA (where θA is an acute angle) with respect to the straight line L and is an inclination surface running toward the apex portion 13b. The second guide surface 13c may be a planar surface or a curved surface. In the example illustrated in FIG. 6, the second guide surface 13c is a planar surface.

The size θA of an inclination angle of the second guide surface 13c is more preferably greater than the size θB of the second guide surface 13c of an inclination angle of the first guide surface 13a.

The size of an angle θC formed by the first guide surface 13a and the second guide surface 13c near the apex portion 13b is not particularly limited and is an obtuse angle in the example illustrated in FIG. 6.

The second spring 17 is an example of a second elastic member that urges the guide member 13 in the Z1 direction. The configuration of the second spring 17 is not particularly limited as long as the guide member 13 can be urged in the Z1 direction. In the example illustrated in FIG. 6, the second spring 17 is a compression coil spring. The second spring 17 is disposed to extend in the Z direction.

The end of the second spring 17 in the Z1 direction is provided on a side of the guide member 13 in the Y2 direction and locks in a lock portion 13g (see a dotted line) extending in the X2 direction.

The end of the second spring 17 in the Z2 direction locks in a second spring holder 20n. The second spring holder 20n is formed as, for example, a depressed portion in the right side plate 20g.

The second spring holder 20n includes a lock portion 20k, that locks the end of the second spring 17 in the Z2 direction and an accommodation hole 20m that guides the side of the second spring 17. A movement range of the lock portion 13g of the guide member 13 in the Z1 direction is regulated by the top surface of the upper portion of the second spring holder 20n.

In the state illustrated in FIGS. 5 and 6, the lock portion 13g is located on the uppermost side (the side in the Z1 direction) inside the second spring holder 20n.

In the state illustrated in FIG. 6, the second spring 17 urges the guide member 13 in the Z1 direction to some extent. When a lock portion (not illustrated) of the guide member 13 pressurized in the Z1 direction from the second spring 17 is regulated by the second spring holder 20n, the front-end edge portion 13B stops in a state in which the front-end edge portion 13B is most moved in the Z1 direction.

For example, when an external force is received in the Z2 direction from the roller 14 coming into contact with the third guide surface 13d, the guide member 13 is rotated clockwise (not illustrated) using the central shaft line O13 as a center up to a position at which the external force is balance with an elastic reaction force of the second spring 17. Thus, the front-end edge portion 13B can be moved in the Z2 direction.

Next, an operation of the image forming apparatus 100 will be described focusing on a reciprocation operation of the paper feed cassette 20 in the sheet supply unit 4.

First, an image forming operation of the image forming apparatus 100 will be described in brief.

In the image forming apparatus 100 illustrated in FIG. 1, an image starts to be formed in accordance with an operation on the control panel 1 or an external signal. When a copy target is read by the scanner unit 2, image information is transmitted to the printer unit 3 or is transmitted to the printer unit 3 from the outside. The printer unit 3 supplies the sheet S from the sheet supply unit 4 to the resist roller 24. The sheet S supplied from the sheet supply unit 4 is selected by the body control unit 6 based on an operation on the control panel 1 or an external signal.

Normally, the user inserts the main body 7 into each paper sheet cassette 20 in a state the sheet S is accommodated in advance.

When an operation input of forming an image is realized from the control panel 1, the body control unit 6 performs control such that the paper feed cassette 20 is selected to feed the sheet S, and then an image starts to be formed.

When a necessary sheet S is not accommodated in the paper feed cassette 20, the body control unit 6 displays a message “Out of paper” on the control panel 1 and reserves start of image formation.

The user draws the paper feed cassette 20 in the state of “Out of paper” from the main body 7, as necessary, and puts the sheet S inside the cassette body 20a. Thereafter, the user inserts the paper feed cassette 20 into the main body 7.

The details of an insertion operation and a drawing operation for the paper feed cassette 20 will be described later.

When the image forming control starts, the image forming units 25Y, 25M, 25C, and 25K form an electrostatic latent image on each photoconductive drum based on image information in accordance with each color. Each electrostatic latent image is developed by each developing unit. Therefore, a toner image corresponding to the electrostatic latent image is formed on the surface of each photoconductive drum.

Each toner image is primarily transferred to the intermediate transfer belt 27 by each transfer roller. Each toner image is overlapped in sequence without color deviation with movement of the intermediate transfer belt 27 to be transmitted to the transfer unit 28.

The sheet S is transported from the resist roller 24 to the transfer unit 28. The toner image arriving at the transfer unit 28 is secondarily transferred to the sheet S. The secondarily transferred toner image is fixed to the sheet S by the fixer 29. In this way, an image is formed on the sheet S.

Next, the details of an operation of inserting the paper feed cassette 20 into the main body 7 and an operation of the paper feed cassette 20 from the main body 7 will be described.

Hereinafter, to facilitate the description, a position or a region located on a side in the Z1 direction more than a specific position in the Z direction is referred to as being on an upper side, being on the upper side, or being higher and an opposite side is referred to as being on a lower side or being lower in some cases in accordance with the disposition of the image forming apparatus 100 illustrated in FIG. 1.

FIG. 6 illustrates an example of a state in which the paper feed cassette 20 is drawn from the main body 7 in the Y1 direction.

At this time, the guide member 13 is located on the side in the Y1 direction than the position of the roller 14 along with the right side plate 20g of the paper feed cassette 20 drawn in the Y1 direction. The guide member 13 is not in contact with the roller 14.

In this case, as indicated by a solid line, the roller 14 is located at the first position P1. In the embodiment, the first spring 16 grows up to the natural length. Since the rotational arm 15 locks in the lock portion (not illustrated), the rotational arm 15 may not be further rotated clockwise (as illustrated) using the rotational support shaft 7c as the center than in this state.

The guide member 13 is urged in the Z1 direction by the second spring 17 and the lock portion 13g locks in the top plate of the second spring holder 20n in the Z1 direction. At this time, a position of the front-end edge portion 13B in the Z direction (hereinafter referred to as a third position P3) is located on the upper side (the side in the Z1 direction) of the center O of the roller 14 at least at the first position P1. In the example illustrated in FIG. 6, the third position P3 is the same position as the uppermost end portion (the end portion of the actuator on the side in the second direction) of the roller 14 at the first position P1 indicated by a point a. Here, the third position P3 may be a position higher than the first position P1 (more separate in the Z1 direction).

When the guide member 13 is moved in the Y2 direction with this positional relation, the first guide surface 13a comes into contact with the side surface of the roller 14 in the Y1 direction. When the third position P3 is higher than the first position P1 and lower than the point a, the front-end edge portion 13B comes into contact with the side surface of the roller 14 in the Y1 direction, the roller 14 is subsequently moved under the second guide surface 13c, and the first guide surface 13a comes into contact with the side surface of the roller 14 in the Y1 direction.

For example, the user pushes the front cover 20b in the Y2 direction in order to insert the paper feed cassette 20 into the main body 7. At this time, since the user does not grip the grip portion 10c (not illustrated), the pressurization portion 10e is located in the Y1 direction and the second arm 11d is substantially horizontal.

Here, the user may insert his or her hand into the opening 20c (not illustrated) to push the paper feed cassette 20 while gripping the grip portion 10c (not illustrated). In this case, since the lock member 11 is in the lock release state, the second arm 11d is in a counterclockwise rotational state (as illustrated).

In this way, in the operation of inserting the paper feed cassette 20 according to the embodiment, the position of the lock member 11 may be a location in the lock state or may be a position in the lock release state. Here, an example in which the lock member 11 is located in the lock state will be described below.

When the paper feed cassette 20 is pushed further in the Y2 direction, as indicated by a two-dot chain line in FIG. 6, the roller 14 is moved in the Z2 direction while rolling along the first guide surface 13a. The first spring 16 is compressed in the Z2 direction.

As the paper feed cassette 20 is pushed in the Y1 direction, the compression of the first spring 16 is pressed in accordance with the inclination of the first guide surface 13a. Elastic energy is accumulated in the first spring 16. Meanwhile, since the rotation of the guide member 13 is regulated by the second spring holder 20n, the protrusion 13C of the guide member 13 is translated in the Y1 direction.

Since the operation of pushing the paper feed cassette 20 accompanies the compression of the first spring 16, the user receives insertion resistance in accordance with a reaction force from the first spring 16 in the Y1 direction. In the embodiment, since the inclination angle θB of the first guide surface 13a is slight, the insertion resistance gradually increases. The magnitude of the insertion resistance is determined by the size of the inclination angle θB and a spring constant of the first spring 16. The insertion resistance may have appropriate magnitude which the user does not feel a burden.

In particular, according to the embodiment, since the first spring 16 is compressed from the natural length, the insertion resistance gradually increases from 0. Therefore, when the roller 14 is at the first position P1, the insertion resistance is smaller than when the first spring 16 is compressed.

An operation of further inserting the paper feed cassette 20 into the main body 7 will be described.

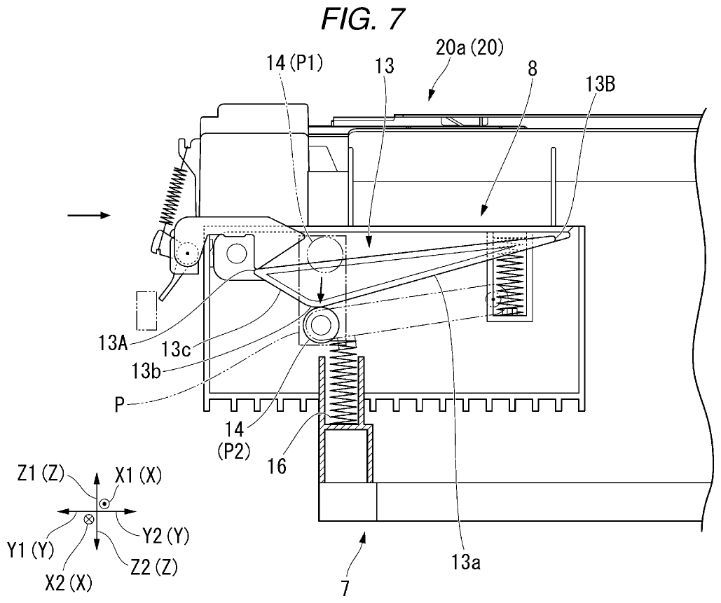

FIGS. 7 to 9 are schematic side views illustrating an operation of inserting the paper feed device according to the embodiment.

As illustrated in FIG. 7, when the paper feed cassette 20 is further pushed in the Y2 direction, the roller 14 comes into contact with the lowermost end of the apex 13b. Thus, the roller 14 is moved from the first position P1 in the Z2 direction along an advance and retreat path P (reciprocation path) and reaches the second position P2. At this time, the first spring 16 is most compressed. An elastic reaction force in the Z1 direction applied to the guide member 13 is the most in the pushing operation.

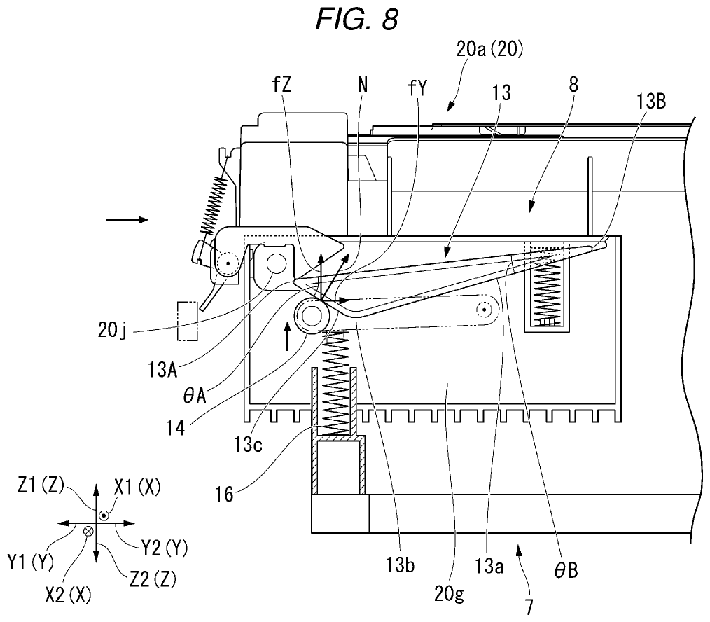

As illustrated in FIG. 8, when the paper feed cassette 20 is further pushed in the Y2 direction, the roller 14 comes into contact with the second guide surface 13c beyond the apex 13b while rolling. At this time, a normal force N is applied to the second guide surface 13c of the guide member 13 from the roller 14 in accordance with the elastic reaction force to the first spring 16. As a result, the guide member 13 receives a component force fZ in the Z direction of the normal force N in the Z1 direction and a component force fY in the Y direction of the normal force N in the Y2 direction.

The component force fY is transmitted to the cassette body 20a via the rotational support shaft 20j. Thus, the cassette body 20a is urged in the Y2 direction by the component force fY. When the roller 14 is moved from the first guide surface 13a to the second guide surface 13c beyond the apex 13b, a component force in the Y direction of the elastic reaction force of the first spring 16 which is the insertion resistance when the roller 14 comes into contact with the first guide surface 13a is reversed in the insertion direction in which the paper feed cassette 20 is pushed in the Y2 direction. Thus, since a force necessary to push the paper feed cassette 20 is drastically reduced, the user can have a feeling of drawing the paper feed cassette 20 into the main body 7 automatically.

The component force fY depends on the magnitude of the elastic reaction force of the first spring 16 and the inclination angle θA of the second guide surface 13c. In the embodiment, θA is greater than θB. Therefore, when the roller 14 is at the same position in the Z direction, the component fY on the second guide surface 13c is greater than the insertion resistance on the first guide surface 13a. The user feels that the magnitude of the insertion resistance is small and the drawing force is large. As a result, the user can obtain a good operational feeling.

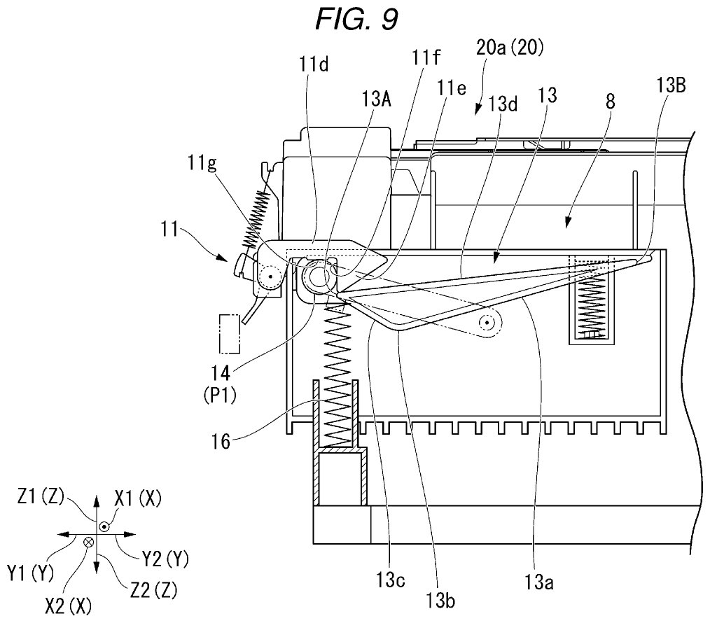

As illustrated in FIG. 9, when the roller 14 reaches the base-end edge portion 13A, the roller 14 is not restricted from the upper side by the second guide surface 13c. The roller 14 is urged to the first spring 16 and is moved above the base-end edge portion 13A. The first lock surface 11f of the lock member 11 is located above the base-end edge portion 13A and the second arm 11d is located horizontally on the side in the Y1 direction than the first lock surface 11f.

Therefore, the roller 14 ascends from the second guide surface 13c along the first lock surface 11f and reaches the first position P1. At this time, the roller 14 locks in the first lock surface 11f and the second lock surface 11g.

In this way, the movement of the paper feed cassette 20 in the Y2 direction stops and the paper feed cassette 20 is positioned in the Y2 direction.

The roller 14 locks in the first lock surface 11f, and thus a lock state in which the movement of the paper feed cassette 20 in the Y1 direction is not possible is realized.

In this way, the insertion of the paper feed cassette 20 into the main body 7 is completed.

Next, an operation of drawing the paper feed cassette 20 from the main body 7 will be described.

When the paper feed cassette 20 is drawn from the main body 7, the lock state of the paper feed cassette 20 is first released by the lock release mechanism 9. Specifically, the user inserts his or her hand into the opening 20c (see FIG. 2) of the paper feed cassette 20 and grips the grip portion 10c of the lock release mechanism 9.

As illustrated in FIG. 4, the release lever 10 is rotated about the central shaft line O10. Thus, the handle 10a is moved in the Y1 direction and the pressurization portion 10e is moved in the Y2 direction. The pressurization portion 10e pressurizes the first arm 11c in the Y2 direction. As a result, the lock member 11 is rotated about the central shaft line O11 and the second arm 11d is rotated upward obliquely with respect to a horizontal plane.

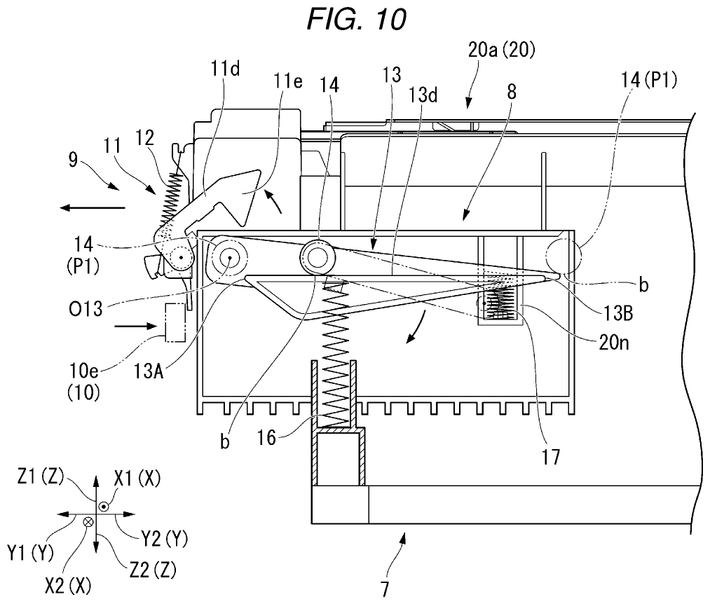

Next, an operation of drawing the paper feed cassette 20 will be described with reference to FIG. 10.

FIG. 10 is a schematic side view illustrating an operation of drawing the paper feed device according to the embodiment.

As illustrated in FIG. 10, the engagement protrusion 11e is moved higher than the roller 14 at the first position P1 (see a two-dot chain line on the left of the drawing) through the above-described lock release operation of operating the grip portion 10c in the lock release mechanism 9. A rotational position of the lock member 11 is a sixth position at which locking of the roller 14 located at the first position P1 in the Y2 direction is not possible. As a result, the lock state of the paper feed cassette 20 in the Y1 direction is released.

When the user pulls the paper feed cassette 20 in the Y1 direction in the state in which the user grips the grip portion 10c, a point b at the lower end portion (an end portion of the actuator opposite to the second direction) of the roller 14 comes into contact with the third guide surface 13d as a result of the movement of the guide member 13 in the Y1 direction. The position of the third guide surface 13d in the Z direction is regulated at the point b at the lower end portion of the roller 14.

The roller 14 rolls over the third guide surface 13d with the movement of the third guide surface 13d. The third guide surface 13d is pressurized in the Z2 direction by the roller 14. As the third guide surface 13d is moved in the Y1 direction along with the paper feed cassette 20, the guide member 13 is rotated clockwise (as illustrated) about the central shaft line O13. Accordingly, the second spring 17 is compressed in the Z2 direction. The third guide surface 13d is rotated up to the height of the point b at the lower end portion of the roller 14 from the state in which the front-end edge portion 13B is above the first position P1 to be horizontal. Since the elastic reaction force of the second spring 17 is not applied in the Y direction, the user can draw the paper feed cassette 20 in the Y1 direction without receiving resistance other than a frictional force between the roller 14 and the third guide surface 13d.

When the front-end edge portion 13B is moved in the Y1 direction from the point b at the lower end portion of the roller 14, the third guide surface 13d is not pressurized by the roller 14. Therefore, the third guide surface 13d is rotated clockwise (as illustrated) by the urging force of the second spring 17.

As illustrated in FIG. 6, the guide member 13 enters a state in which the front-end edge portion 13B is moved above at least the first position P1.

Thereafter, the user can draw the paper feed cassette in the Y1 direction without receiving the resistant force from the drawing mechanism 8.

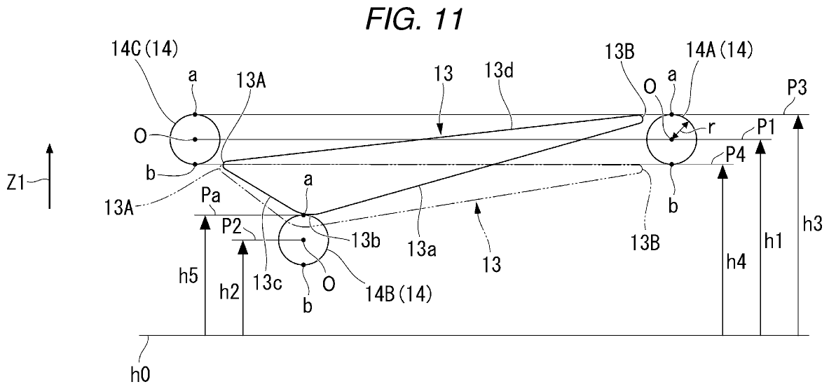

Next, a relative motion between the guide member 13 and the roller 14 in the insertion operation and the drawing operation for the paper feed cassette 20 according to the embodiment will be summarized with reference to FIG. 11.

FIG. 11 is a schematic view illustrating a relative motion of an actuator and a guide member of the paper feed device according to the embodiment.

In FIG. 11, the above-described first position P1, second position P2, third position P3, and fourth position P4 are indicated by heights h1, h2, h3, and h4 from a suitable standard position h0 lower than the second position P2. The position of the roller 14 is indicated at the position of a central shaft line O of the roller 14.

When r is a radius of the roller 14, for example, there are relations of h3=h1+r, h4=h1−r, and h2<h4 in the embodiment. Here, h1−h2 is equivalent to a maximum compression amount of the first spring 16. In addition, h3−h4=2×r is equivalent to a maximum compression amount of the second spring 17.

A rotational amount of the guide member 13 is equivalent to h3−h4 as a distance of the front-end edge portion 13B in the Z direction. In the embodiment, the base-end edge portion 13A is located slightly lower than the fourth position P4, as indicated by a two-dot chain line, when the guide member 13 is rotated. Here, the fourth position of the base-end edge portion 13A is not particularly limited as long as the fourth position is below the first position P1.

When the position of the guide member 13 is fixed, the roller 14 near the guide member 13 performs relative movement of orbiting around the outer circumferences of the first guide surface 13a, the apex portion 13b, the second guide surface 13c, and the third guide surface 13d with respect to the guide member 13 with the movement of the paper feed cassette 20.

In the following description, the roller 14 at the first position P1 near the front-end edge portion 13B is referred to as a roller 14A, the roller 14 at the second position P2 at which the point a comes into contact with the lowermost end of the second guide surface 13c is referred to as a roller 14B, and the roller 14 at the first position P1 near the base-end edge portion 13A is referred to as a roller 14C.

In the operation of inserting the paper feed cassette 20, the roller 14 descends from the position of the roller 14A along the second guide surface 13c to be moved up to the roller 14B when the guide member 13 is at a position indicated by a solid line. The lowermost end of the apex portion 13b is located at a height h5=h2+r.

While the roller 14 is transferred from the roller 14B to the roller 14C, a drawing force of the drawing mechanism 8 is applied to the guide member 13.

The roller 14C is considered to be in the lock state by the drawing mechanism 8 (not illustrated).

In this way, the insertion operation ends.

In the drawing operation, the guide member 13 is rotated, as indicated by a two-dot chain line, while the roller 14 is transferred from the roller 14C to the roller 14A. When the roller 14 is moved relative to the guide member 13 to the right side of the roller 14A (as illustrated), the guide member 13 is rotated by the urging force of the second spring 17 (not illustrated), as indicated by the solid line. Thus, the roller and the guide member 13 are mutually separated and interaction disappears.

As described above, in the embodiment, in the operation of inserting the paper feed cassette 20, the guide member 13 is moved in the Y2 direction in the state in which the roller 14 is moved under the second guide surface 13c, the second guide surface 13c, and the first guide surface 13a which is the lower end surface of the protrusion 13C. Thus, since the paper feed cassette 20 is drawn in the Y2 direction from the time at which the roller 14 climbs over the second guide surface 13c in the Y1 direction, a smooth and reliable insertion operation is performed.

For example, when the user stops pushing the paper feed cassette 20 before the roller 14 climbs over the apex portion 13b, the paper feed cassette 20 stops in a state in which the insertion resistance is received from the roller 14. Therefore, it is clear that the insertion may not be completed.

For example, when the user stops pushing the paper feed cassette 20 after the roller 14 climbs over the apex portion 13b, a drawing force is applied from the roller 14, the paper feed cassette 20 is therefore automatically drawn, and the roller 14 locks in the lock release mechanism 9.

In particular, when the roller 14 is located at the first position P1, the first spring 16 is set to have the natural length. Then, since the insertion resistance can be reduced when the roller 14 rolls along the first guide surface 13a, the insertion operation can be performed with a lighter load.

In this case, when the roller 14 climbs the second guide surface 13c, the first spring 16 is most compressed. Therefore, an elastic reaction force for realizing the drawing force is ensured.

In the operation of drawing the paper feed cassette 20, the roller 14 rolls the horizontally located third guide surface 13d by the rotation after the lock release state is realized by the lock release mechanism 9. Therefore, the user rarely receives the resistance load from the drawing mechanism 8. Thus, the user can easily draw the paper feed cassette 20.

In the embodiment, the roller 14 of the drawing mechanism 8 also serves as an engagement member that is switched between a lock state and a load release state by the lock release mechanism 9. Therefore, the configuration of the device is simplified.

As described above, for the sheet supply unit 4 according to the embodiment, since the drawing mechanism 8 includes the roller 14 supported to be able to reciprocate in the Z direction, the first spring 16, and the guide member 13, easy and reliably insertion can be realized when the paper feed cassette 20 is inserted and drawing with a low load can be realized when the paper feed cassette 20 is drawn.

Thus, in the image forming apparatus 100 according to the embodiment, it is easy to supply and exchange the sheet S in the paper feed cassette 20.

According to at least one of the above-described embodiments, it is possible to provide the image forming apparatus and the paper feed device in which it is easy to insert and draw the cassette.

Hereinafter, modification examples of the above-described embodiments will be described.

In the foregoing embodiment, the actuator of the drawing mechanism 8 is formed as the roller 14. Since the roller 14 rolls on the first guide surface 13a, the apex portion 13b, the second guide surface 13c, and the third guide surface 13d of the guide member 13, the frictional resistance with the guide member 13 can be reduced. However, the actuator may not be a rotator when the actuator is slidable with low friction with the guide member 13. For example, a non-rotator formed of a material with a low coefficient of friction with respect to the guide member 13 may be used as the actuator. At this time, in order to reduce sliding friction with the guide member 13, it is more preferable to form a curved surface, a protrusion group, or the like on the surface.

As described above in the embodiment, the protrusion 13C of the guide member 13 has the shape protruding straightly from the substrate 13e in the X direction. Therefore, the cross sections orthogonal to the substrate 13e on the first guide surface 13a, the apex portion 13b, the second guide surface 13c, and the third guide surface 13d are all straight lines extending in the X direction.

However, for the first guide surface 13a, the apex portion 13b, the second guide surface 13c, and the third guide surface 13d, an arched cross section or a curved surface with a convex shape protruding on the outside of the protrusion 13C may be used in the cross section orthogonal to the substrate 13e. In this case, more preferably, the roller 14 has a concave shape engaging with the convex shape on the outer circumference.

Similarly, for the first guide surface 13a, the apex portion 13b, the second guide surface 13c, and the third guide surface 13d, a V-shaped cross section or a curved surface with a concave shape depressed on the inside of the protrusion 13C may be used in the cross section orthogonal to the substrate 13e. In this case, more preferably, the roller 14 has a concave shape engaging with the convex shape on the outer circumference.

As described above in the embodiment, the first lock surface 11f is formed as the fourth guide surface. However, the fourth guide surface may be an inclination surface intersecting a part locking the roller 14 on the first lock surface 11f. For example, the fourth guide surface may have the same inclination or substantially the same inclination as the second guide surface 13c. In this case, the fourth guide surface can guide the roller 14 particularly smoothly up to the locking part of the first lock surface 11f from the second guide surface 13c.

As described above in the embodiment, the movement direction of the actuator from the second position to the first position is the Z1 direction. However, the movement direction of the actuator from the second position to the first position may be the Z2 direction. In this case, the positional relation between the guide member 13 and the roller 14 may be reversed in the Z direction with respect to the above-described embodiment.

Further, the movement direction of the actuator from the second position to the first position is not limited to the Z direction as long as the movement direction is a direction intersecting the reciprocation direction (the first direction and the opposite direction to the first direction) of the cassette. For example, the movement direction of the actuator may be the X direction or may be a direction orthogonal to the Y direction and obliquely oriented in the Z and X directions.

For example, when the movement direction of the actuator is the X direction, the drawing mechanism 8 may be provided between the base 7a and the cassette body 20a.

As described above in the embodiment, the first and second elastic members are formed as coil springs. However, the first and second elastic members are not limited to the coil springs. For example, a suitable spring or elastic body, or the like that can urge the actuator reciprocating between the first and second positions in the second direction by the urging force may be used as the first elastic member. For example, a suitable spring or elastic body, or the like that can urge the front end portion of the guide member to be movable between the third and fourth positions may be used as the second elastic member.

As described above in the embodiment, the front end portion of the guide member can be moved between the third and fourth positions when the guide member is entirely rotated. However, the guide member may be configured so that only a part near the front end portion can be moved as long as the front end portion can be moved.

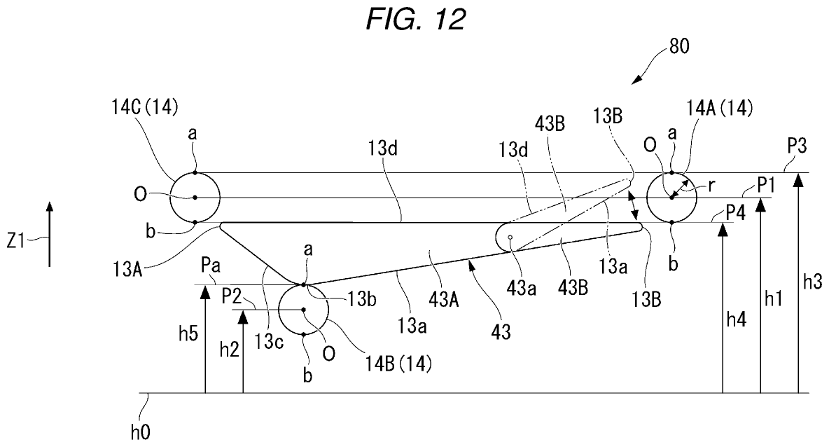

FIG. 12 is a schematic view illustrating an example of a guide member of a paper feed device according to a modification example of the embodiment.

For example, instead of the drawing mechanism 8 according to the foregoing embodiment, a drawing mechanism 80 illustrated in FIG. 12 may be used. The drawing mechanism 80 includes a guide member 43 instead of the guide member 13 of the drawing mechanism 8.

The guide member 43 includes a flapper 43B and a fixed guide 43A.

The flapper 43B includes a front-end edge portion 13B and includes the first guide surface 13a and the third guide surface 13d near the front-end edge portion 13B, as in the guide member 13. The flapper 43B is supported by a rotational portion 43a provided in the front end portion of the fixed guide 43A to be described below to be rotatable. The flapper 43B is urged by the second spring 17 (not illustrated) as in the embodiment and is considered to be movable similarly between the third and fourth positions.

In FIG. 12, the flapper 43B indicated by a solid line is located at the fourth position. The flapper 43B indicated by a two-dot chain line is rotated toward the third position, as illustrated.

The fixed guide 43A is provided with a shape in which an outer circumference including the first guide surface 13a, the apex portion 13b, the second guide surface 13c, and the third guide surface 13d can be formed, as in the guide member 13 of the embodiment, along with the flapper 43B when the flapper 43B is located at the fourth position. Here, the fixed guide 43A and the right side plate 20g (not illustrated) are fixed to each other.

According to the modification example, the roller 14 at the first position can be relatively moved from the base-end edge portion 13A to the front-end edge portion 13B. At this time, since the roller 14 is moved to press the flapper 43B downward (as illustrated) on the third guide surface 13d of the flapper 43B, the flapper 43B is rotated so that the front-end edge portion 13B is oriented from the fourth position to the third position. When the roller 14 passes the front-end edge portion 13B (see the roller 14A), the flapper 43B is urged by the second spring 17 (not illustrated) to return to the fourth position.

Therefore, When the roller 14A is relatively moved to the lift (as illustrated), the roller 14A can be moved up to the second position along the first guide surface 13a of the fixed guide 43A and the flapper 43B.

In this way, according to the modification example, the rotation of the flapper 43B enables the relative movement of the guide member 43 on the outer circumference, as in the embodiment, except that the inclination of the first guide 13a and the third guide surface 13d in the flapper 43B is switched. As a result, when the paper feed cassette 20 is inserted, a drawing force is applied from the drawing mechanism 80 as in the embodiment. Similarly, when the paper feed cassette 20 is drawn, the roller 14 can be smoothly moved on the third guide surface 13d. Therefore, drawing with a low load is possible.

The modification example is an example in which the drawing mechanism includes a rotational portion rotating a part of the guide member.

Herein, a mechanism that reciprocates the front-end edge portion 13B between the third and fourth positions is not limited to the rotational mechanism. For example, the fixed guide 43A and the flapper 43B may be bendably connected to each other at the position of the rotational portion 43a.

As described above in the embodiment, the image forming apparatus 100 is assumed to be a multi-function peripheral (MFP) which is a tandem type multi-function peripheral for four colors using electrophotography. However, the image forming apparatus 100 is not limited to the tandem type configuration. Further, the image forming apparatus 100 may be a monochromatic multi-function peripheral or printer.

Further, the image forming apparatus 100 may be an inkjet type or thermal transfer type of a multi-function peripheral, printer, copy machine, or the like.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A paper feed device, comprising:
a cassette configured to load a sheet;
a main body configured to support the cassette so that the cassette reciprocates in a first direction and an opposite direction to the first direction;
an actuator supported by the main body in a second direction intersecting the first direction so that the actuator is configured to reciprocate between a first position and a second position located separately more than the first position in an opposite direction to the second direction;
a first elastic member configured to be urged in the second direction by the actuator; and
a guide member disposed in the cassette so that the guide member is configured to cross along a reciprocation path of the actuator in the second direction when the cassette reciprocates and to include a front end portion located upstream in the first direction, a base end portion located downstream, and a guide unit that includes an apex portion formed between the base end portion and the front end portion and overhanging in the opposite direction to the second direction, wherein
the base end portion is located in the second direction at the same position as an end portion of the actuator located at the first position on an opposite side to the second direction or a third position located separately more than the end portion in the opposite direction to the second direction,
the front end portion is provided in the second direction movable between the third position and a fourth position located separately more than the first position in the second direction, and
the guide unit is provided so that the apex portion is disposed at the same position as the end portion of the actuator in the second direction at the second position in the second direction.

2. The device according to claim 1, wherein
the guide member is rotatable in the cassette via a rotational portion provided at the base end portion so that a position of the front end portion is switched between the third and fourth positions.

3. The device according to claim 2, further comprising:
a second elastic member configured to urge the front end portion of the guide member in a rotational direction oriented from the third position to the fourth position at a position away from the rotational portion.

4. The device according to claim 1, wherein
the guide unit includes:
a first guide surface inclined with respect to a straight line binding the base end portion to the front end portion and to extend from the front end portion to the apex portion; and
a second guide surface inclined with respect to the straight line and to extend from the base end portion to the apex portion.

5. The device according to claim 1, wherein
the actuator is a roller.

6. The device according to claim 4, wherein
a magnitude of inclination of the first guide surface with respect to the straight line is less than a magnitude of inclination of the second guide surface with respect to the straight line.

7. The device according to claim 3, wherein
the apex portion has a curved surface with a convex shape smoothly connecting the first guide surface to the second guide surface.

8. The device according to claim 1, further comprising:
a stopper provided in the cassette and configured to be movable between a fifth position at which the actuator is able to lock in the actuator located at the first position in the first direction and a sixth position in which the actuator located at the first position is not able to lock in the first direction; and
a stopper release operation unit configured to move the stopper from the fifth position to the sixth position.

9. The device according to claim 8, wherein
the stopper includes a fourth guide surface that extends in a direction intersecting the first direction and a front end of the fourth guide surface in the extension direction is located near the base end portion at the fifth position.

10. An image forming apparatus, comprising:
an image forming component configured to form an image on a sheet; and
a paper feed device, comprising:
a cassette configured to load the sheet;
a main body configured to support the cassette so that the cassette reciprocates in a first direction and an opposite direction to the first direction;
an actuator supported by the main body in a second direction intersecting the first direction so that the actuator is configured to reciprocate between a first position and a second position located separately more than the first position in an opposite direction to the second direction;
a first elastic member configured to be urged in the second direction by the actuator; and
a guide member disposed in the cassette so that the guide member is configured to cross along a reciprocation path of the actuator in the second direction when the cassette reciprocates and to include a front end portion located upstream in the first direction, a base end portion located downstream, and a guide unit that includes an apex portion formed between the base end portion and the front end portion and overhanging in the opposite direction to the second direction, wherein
the base end portion is located in the second direction at the same position as an end portion of the actuator located at the first position on an opposite side to the second direction or a third position located separately more than the end portion in the opposite direction to the second direction,
the front end portion is provided in the second direction movable between the third position and a fourth position located separately more than the first position in the second direction, and
the guide unit is provided so that the apex portion is disposed at the same position as the end portion of the actuator in the second direction at the second position in the second direction.

11. The apparatus according to claim 10, wherein
the guide member is rotatable in the cassette via a rotational portion provided at the base end portion so that a position of the front end portion is switched between the third and fourth positions.

12. The apparatus according to claim 11, further comprising:
a second elastic member configured to urge the front end portion of the guide member in a rotational direction oriented from the third position to the fourth position at a position away from the rotational portion.

13. The apparatus according to claim 10, wherein
the guide unit includes:
a first guide surface inclined with respect to a straight line binding the base end portion to the front end portion and to extend from the front end portion to the apex portion; and
a second guide surface inclined with respect to the straight line and to extend from the base end portion to the apex portion.

14. The apparatus according to claim 10, wherein
the actuator is a roller.

15. The apparatus according to claim 13, wherein
a magnitude of inclination of the first guide surface with respect to the straight line is less than a magnitude of inclination of the second guide surface with respect to the straight line.

16. The apparatus according to claim 12, wherein
the apex portion has a curved surface with a convex shape smoothly connecting the first guide surface to the second guide surface.

17. The apparatus according to claim 10, further comprising:
a stopper provided in the cassette and configured to be movable between a fifth position at which the actuator is able to lock in the actuator located at the first position in the first direction and a sixth position in which the actuator located at the first position is not able to lock in the first direction; and
a stopper release operation unit configured to move the stopper from the fifth position to the sixth position.

18. The apparatus according to claim 17, wherein
the stopper includes a fourth guide surface that extends in a direction intersecting the first direction and a front end of the fourth guide surface in the extension direction is located near the base end portion at the fifth position.

19. A paper feed method, comprising:
reciprocating a cassette configured to load a sheet in a first direction and an opposite direction to the first direction;
reciprocating an actuator, supported in a second direction intersecting the first direction, between a first position and a second position located separately more than the first position in an opposite direction to the second direction;
urging a first elastic member in the second direction by the actuator; and
crossing a guide member along a reciprocation path of the actuator in the second direction when the cassette reciprocates, the guide member comprising a front end portion located upstream in the first direction, a base end portion located downstream, and a guide unit that includes an apex portion formed between the base end portion and the front end portion and overhanging in the opposite direction to the second direction, the base end portion is located in the second direction at the same position as an end portion of the actuator located at the first position on an opposite side to the second direction or a third position located separately more than the end portion in the opposite direction to the second direction, the front end portion is provided in the second direction movable between the third position and a fourth position located separately more than the first position in the second direction.

20. The method according to claim 19, wherein
rotating the guide member in the cassette via a rotational portion provided at the base end portion so that a position of the front end portion is switched between the third and fourth positions.
